(19) United States
(12) Patent Application Publication
(10) Pub. No.: US 2013/0045462 A1
(43) Pub. Date: Feb. 21, 2013

(54) DENTAL IMPLANT FIXING SYSTEM

(71) Applicant: Yu-Hong Tzeng, Taipei City (TW)

(72) Inventor: Yu-Hong Tzeng, Taipei City (TW)

(21) Appl. No.: 13/211,979

(22) Filed: Aug. 17, 2011

(51) Int. Cl. A61C 8/00

(52) U.S. Cl. 433/174

(57) ABSTRACT

A dental implant fixing system including an implant having a cylindrical main body with a thread division outside; characterized in that the end part of said thread division has a conical shape, narrowing from top to bottom, a recessed conical screw set on the center of the end front and wherein the wall of said conical screw and the outer side of said end part approach each other inclined at bottom.

### FIELD OF THE INVENTION

The present invention relates to a dental implant fixing system, particularly to a dental fixing implant system used for implanting surgery for fixing a prosthetic tooth in an artificial tooth root of an oral alveolar bone.

### BACKGROUND OF THE INVENTION

In conventional implanting surgery, a dental implant (or an artificial tooth root) is embedded in the oral alveolar bone of a patient, then a prosthetic tooth is positioned in the gums of the patient.

A conventional implant usually has a cylindrical shape, having an outer thread division at a lower section, which is screwed into the oral alveolar bone of the patient's mouth. The thread division has an abutment on a top thereof to accommodate a prosthetic tooth over the dental implant.

The process of implant surgery has two phases: firstly, drilling into the alveolar bone, generating a pre-drilled hole; secondly, screwing an implant in the hole inside the alveolar bone. In an early period of screwing, when the alveolar hone still has no osseointegration with the dental implant, a stress-free period is required to avoid a micro-motion which can cause loosening of new bone tissue. So after the dental implantation, the gum usually will be temporarily sutured. It is waited until osseointegration is finished, then the second phase is performed: opening the gum, fixing an abutment in the dental implant, finally manufacturing a prosthetic tooth over the abutment.

For improving stability of implantation in alveolar bone as well as promoting osseointegration between implant and alveolar bone, the thread division of conventional implant is usually designed as a self-tapping thread, having grooves as sharp incisions on its end part, so that the thread division tightly engages with the alveolar bone when screwed into the pre-drilled hole of the alveolar bone. Thereby, resistance by implanting is reduced and stability after implantation is achieved.

However, such an conventional implant usually has a lower end under the thread division which is planar or curved. Accordingly, when the thread division is screwed into the pre-drilled hole in the alveolar bone, bone chips, which accumulate on the lower end of the thread division, cause increasing resistance, so that more clamping force is required.

Clamping torque resulted by screwing has to be limited, since in case of high strength, heat resulting from friction between the thread division and the alveolar bone causes occasions necrosis of the alveolar bone. Furthermore, increasing pressure between the thread division and the alveolar bone resulting form the resistance by the bone chips causes crumbling of the implanted location, even breaking of the implant.

Besides, for improving stability of implantation in the earlier period, and furthering osseointegration between implant and alveolar hone, in conventional art occasionally a recessed screw is set at the lower end of the thread division of the implant. When the thread division is screwed into the pre-drilled hole, bone chips below the implanting hole are driven into the recessed screw, inducing growth of the alveolar bone and filling the recessed screw. So is osseointegration achieved.

Since in an conventional implant the lower end of the thread division is planar or curved, bone chips from the implanting hole accumulated undebelow the lower end of the thread division do not easily get into said recessed screw. Therefore, the effect of the recessed screw for osscointegration is limited.

### SUMMARY OF THE INVENTION

The main object of the present invention is to provide a dental implant fixing system for reducing clamping torque and promoting complete osseointegration, so that a higher success rate of implanting surgery is achieved.

For achieving above objects, the present invention comprises an implant, having a cylinder main body with an outer thread division to be screwed into the oral alveolar bone of a patient; characterized in that: the thread division has an end part at a bottom, with a recessed conial screw located at a frontal central position at the end part which has a conical shape, narrowing from top to bottom; where the conial screw has a relatively narrow diameter on a top end and a relatively wide diameter on a bottom end thereof. Thus a wall of the conial screw and an outer side of the end part approach each other inclined at bottom.

In this way, the thickness of a gap between the opening of the conial screw and the outer side of the end part of the thread division is reduced. Reduced resistance of implanting results. Furthermore, width and area of the bottom are also reduced, and accumulation of bone chips at bottom is avoided. Accordingly bone chips can easily get into the conial screw for promoting osseointegration.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a side view of the implant in the first embodiment of the present invention.

FIG. 2 is a perspective view of the implant in the first embodiment of the present invention.

FIG. 3 is a profile of the implant in the first embodiment of the present invention.

FIG. 3A is an enlarged local profile of the end part of the implant of the present invention.

FIG. 3B is a bottom view of the end part of the implant of the present invention.

FIG. 4 is a cross-sectional side view of the implant in the first embodiment of the present invention: an implant being implanted in an oral alveolar bone of a patient and set with a prosthetic tooth.

FIG. 5 is a local profile of the implant in the second embodiment of the present invention.

### DESCRIPTION OF THE PREFERRED EMBODIMENTS

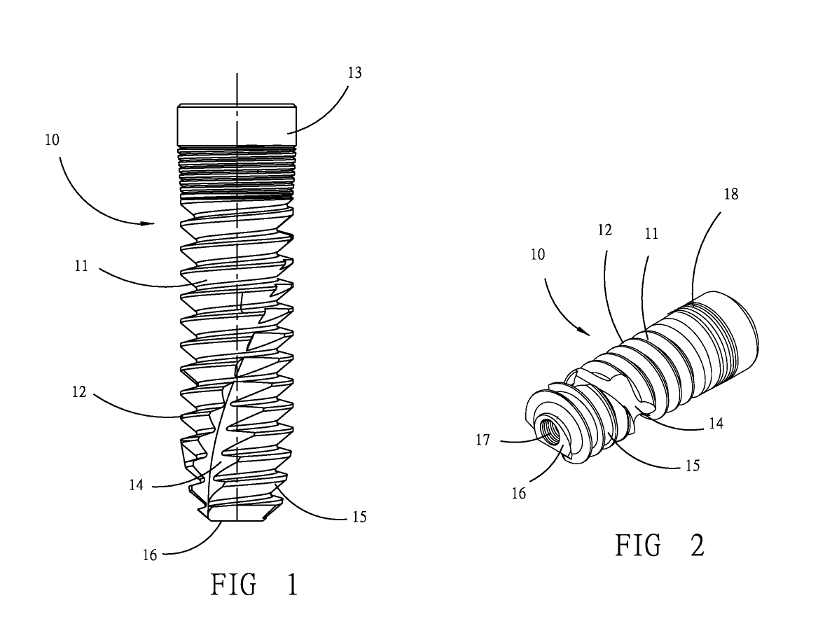

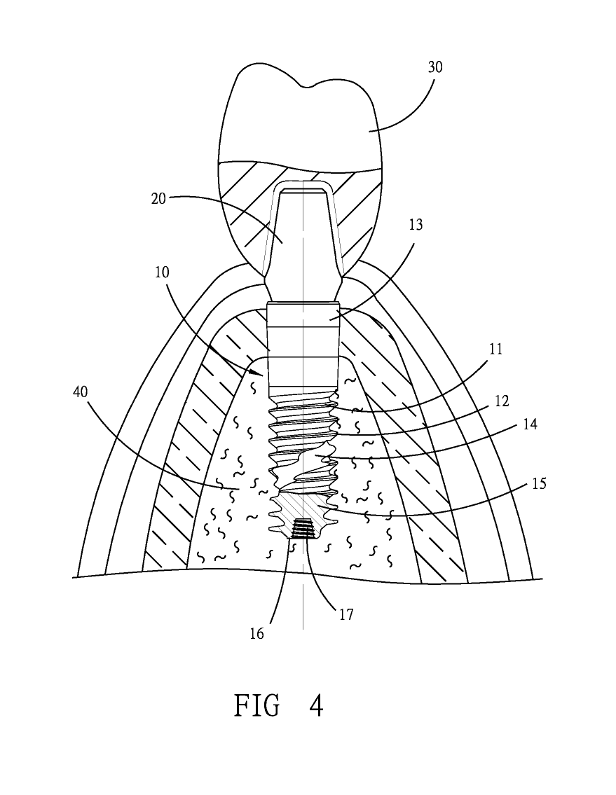

FIGS. 1-4 show the first embodiment of the dental implant fixing system of the present invention, which comprises an implant 10 in a cylindrical shape. Defined by the implanting direction into an oral alveolar bone 40, the implant 10 has an upper part and a bottom part. The bottom part of the implant 10 is a main body 11 in cylindrical shape, having a thread division 12 outside, for engaging with the alveolar bone, while the upper part has a neck part 13 with line thread 18 outside. At the same time, the neck part 13 is jointed with an abutment 20 on top, which is mounted with a prosthetic tooth 30 over the implant 10 (as shown in FIG. 4).

As shown in FIG. 2, the thread division 12 has an end part 15 at the bottom as a self-tapping thread. At least one groove 14 extending outside from the end part 15 to the main body 11 is set on the thread division 12, for easily engaging with the tissue of the alveolar bone. Further, the groove 14 can hold bone chips caused by cutting the alveolar bone with the thread division 12. For improving blood affinity as well as sealing ability after the osseointegration, the surface of thread 12 is handled either by blasting, chemical etching or plasma treatment.

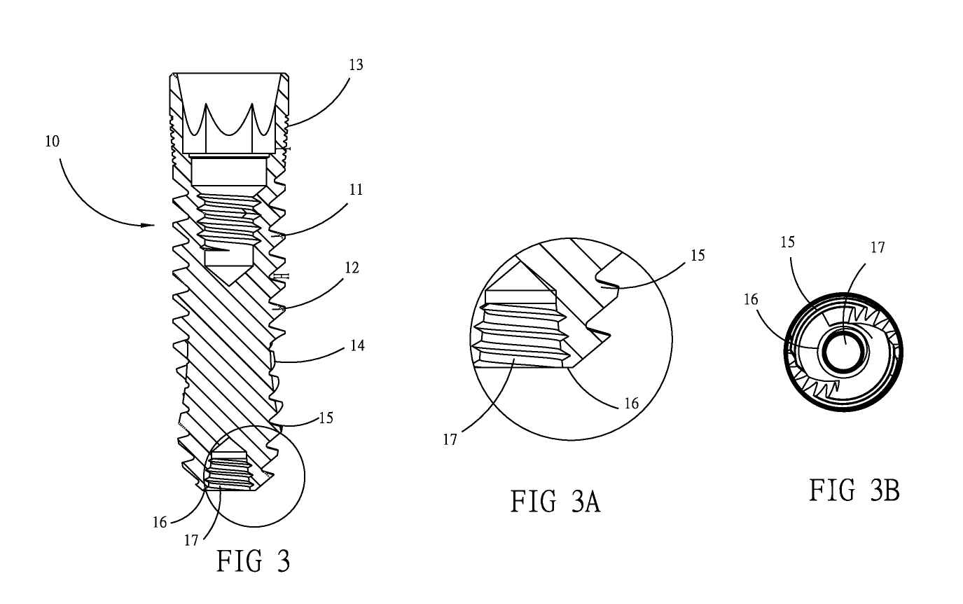

As shown in FIGS. 3 and 4, on an lower end 16 of said end part 15 of the present invention is a recessed conial screw 17, which can hold the bone chips of the alveolar bone under the lower end 16. Accordingly, stability of implanting is increased on the one hand, and bone chips and blood can be embedded in the conial screw 17 on the other hand. So tissue of the alveolar bone will grow and fill the space or the conial screw 17 after osseointegration.

The main characteristics of the present invention are: the end part 15 of the thread division 12 has a conical shape, narrowing from top to bottom, and the conial screw 17 with a narrower diameter on top and a wider one at bottom. So the wall of the conial screw 17 and the outer side of the end part 15 approach each other inclined at bottom. Therefore, the thickness of a gap between the opening of the conial screw 17 and the outer side of the end part 15 of the thread division 12 reduces. As shown in FIG. 3B, the width and area of the lower end 16 of the end part 15 reduce.

According to the system mentioned above, the clamping torque loaded on the end part 15 through implanting reduces. So the implant of the present invention can prevent heat generated by excessive resistance and promote success rate of implanting surgery. Besides, due to reduced width and area of the lower end 16, bone chips will not easily accumulate at bottom of the lower end 16, so more bone chips can get inside within the conial screw 17. A stable osseointegration between the alveolar bone and the conial screw 17 is achieved.

Furthermore, regarding sufficient strength on the end part 15 of the thread division 12 and reduced accumulation of bone chips, preferably the width of the lower end 16 is kept in the range 0.2 mm˜1 mm, since an over narrow lower end 16 can cause weakness of the thread.

The implant 10 in the first embodiment of the present invention is a multistage design, that is, the implant 10 and the abutment 20 for mounting the prosthetic tooth 30 are separated objects. As shown in FIG. 4, implanting surgery is performed firstly by drilling on where the denture is located, then screwing the implant 10 in the hole of the oral alveolar bone 40.

During normal implanting surgery, once the implant 10 is embedded in the implanting hole, gums are firstly sutured. After osseointegration is performed, the surgery will be handled again, let the implant 10 extend beyond the gums. Then the abutment 20 is jointed over the neck part 13. Thereafter, the prosthetic tooth 30 will be mounted over the abutment 20.

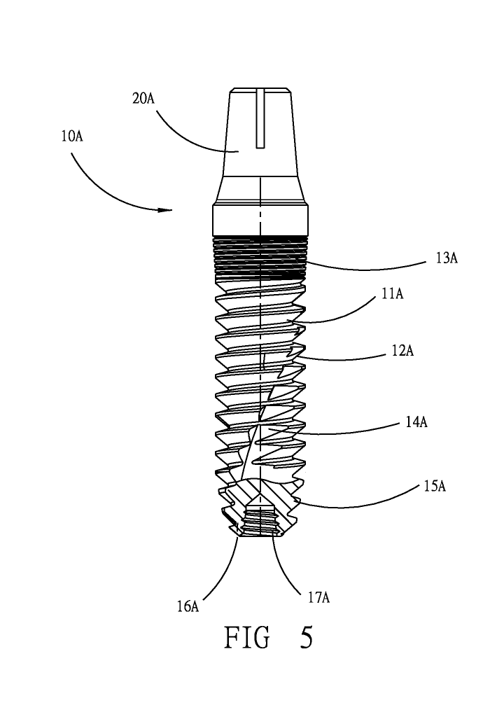

FIG. 5 shows the second embodiment of the present invention, which is applied to monobloc implant, wherein the implant 10A is in one piece combined with the abutment 20 to fix prosthetic tooth. The implant 10A comprises at bottom a main body 11A, connecting an end part 15A beneath. Outside the main body 11A and the end part 15A there is thread division 12A. A conial screw 17A is set at center of the lower end 16A of the end part 15A.

The second as well as the first embodiment of the present invention have the same characteristics, that is, the thread division 12A, main body 11A, end part 15A, conial screw 17A, lower end 16A have the same characteristics as the thread division 12, main body 11, end part 15, conial screw 17 and lower end 16, respectively. Accordingly, their description is omitted.

The present invention allows higher success rate of implantating surgery and furthermore a more complete osseointegration. While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A dental implant fixing system;
comprising an implant having an upper part and a bottom part defined by the implantation direction into an alveolar bone;
comprising a thread division on said bottom part, which can be screwed in the said alveolar bone;
characterized in that;
said thread division has a lower and an upper end part and at least one spiral groove extending from said lower end and said upper end of the thread division;
and on the lower end of said end part, at a central position a recessed conical screw is mounted, having a narrower diameter on top and wider one at bottom; therefore, a wall or said conical screw and an outer side of said end part approach each other inclined at bottom.

2. The dental implant fixing system of claim 1, wherein said lower end has a width of 0.2 mm 1 mm.

3. (canceled)

4. The dental implant fixing system of claim 1, wherein said abutment and implant are separated objects.

5. The denial implant fixing system of claim 1, wherein said abutment is jointed in one piece over said implant.
